(19) United States
(12) Patent Application Publication
(10) Pub. No.: US 2010/0069188 A1
(43) Pub. Date: Mar. 18, 2010

(54) SILENT CHAIN

(75) Inventors: Shouhei Adachi, Osaka (JP); Takayuki Morimoto, Osaka (JP)

Correspondence Address: HOWSON & HOWSON LLP, 501 OFFICE CENTER DRIVE, SUITE 210, FORT WASHINGTON, PA, 19034, US

(73) Assignee: TSUBAKIMOTO CHAIN CO., Osaka (JP)

(21) Appl. No.: 12/542,125

(22) Filed: Aug. 17, 2009

(30) Foreign Application Priority Data
Sep. 16, 2008 (JP) 2008-236760

(51) Int. Cl. F16G 13/04; F16G 13/07

(52) U.S. Cl. 474/213

(57) ABSTRACT

In a silent chain having interleaved joint link plates and guide link plates each having a pair of teeth and a pair of pin holes, the pin holes in each of the joint link plate are elongated in the direction of elongation of the chain, and extend toward each other from the two connecting pins extending through the pin holes so that a gap is formed between each of the two connecting pins and the other. The pin holes of each of the toothed guide link plates are circular pin holes. The elongation of the pin holes of the joint link plates allows the joint links to shift longitudinally with respect to the guide link plates on engagement of the chain with a sprocket, reducing clashing noise.

### CROSS-REFERENCE TO RELATED APPLICATION

This application claims priority on the basis of Japanese patent application 2008-236760, filed Sep. 16, 2008. The disclosure of Japanese application 2008-236760 is hereby incorporated by reference.

### FIELD OF THE INVENTION

This invention relates to a silent chain used of the kind used in the timing drive of an internal combustion engine or for power transmission in various kinds of machinery. The invention relates more specifically to an improvement in silent chains for reducing clashing noise generated as the teeth of the chain come into engagement with a sprocket.

### BACKGROUND OF THE INVENTION

In a silent chain, a plurality of joint link plates and guide link plates, each having a pair of pin holes and being bifurcated to form a pair of teeth, are respectively arranged in alternate joint link rows (also sometimes referred to as “non-guide” rows) and guide rows. Guide plates, each having a pair of pin holes, are disposed along the sides of the chain at the opposite ends of each guide row. The joint link plates and the guide link plates are interleaved, and connected by connecting pins that are fixed to the pin holes of the guide plates and inserted through pin holes of the joint link plates and the guide link plates.

The silent chains have various engagement types depending on the shapes of their teeth. A well-known type of silent chain is the so-called inner flank engagement/outer flank seating chain, in which, as chain comes into engagement with a sprocket, the inner flanks of the teeth contact the sprocket teeth first, and, as the chain wraps around the sprocket, it seats by engagement of the outer flanks of its teeth with the sprocket teeth. Another well-known type of silent chain is the outer flank engagement/outer flank seating chain. For further details of the various types of silent chains, reference can be made to Japanese Laid-Open Patent Publications No. 2008-138789 and No. 2000-329199, and to U.S. Pat. No. 6,334,828.

In the inner flank engagement/outer flank seating silent chain, when a tooth of each plate engages a sprocket tooth, an inner flank of a front tooth of a link plate, i.e., a forward tooth of the plate with reference to the direction of travel of the chain, comes into contact with a sprocket tooth. As the chain continues to advance, the engagement point moves along the sprocket tooth surface toward the bottom of a tooth gap of the sprocket. As a result of this movement of the engagement point, the engagement is transferred from the inner flank to the outer flank, and both outer flanks of the plate slide along sprocket tooth surfaces toward sprocket tooth gap bottoms. As the plate becomes fully engaged with the sprocket, its outer flanks are in seating contact with sprocket teeth.

In the outer flank engagement/outer flank seating type silent chain, an outer flank of a rear tooth in the chain advancing direction first comes into contact with a sprocket tooth at the beginning of engagement. The engagement point moves along a sprocket tooth surface. During this movement, a flank of a front tooth also comes into contact with a sprocket tooth and engages therewith. Upon completion of engagement, the outer flanks are both seated. In this case, only the outer flanks of the plate tooth come into contact with sprocket teeth during the engagement with the sprocket teeth.

In FIG. 10, which is a cross-sectional view of a part of a conventional silent chain 21, joint link plates 23 each having a pair of circular pin holes 22 and a pair of teeth (not shown) are arranged in a joint link or “non-guide” rows JL, and guide link plates 25, each having a pair of circular pin holes 24 and a pair of teeth (not shown) are arranged in guide rows GL and Guide plates 27, each having a pair of pin holes 26 are arranged at the opposite ends of each guide row GL.

The joint link plates 23 and the guide link plates 25 are interleaved, and connecting pins 28, fixed to the pin holes 26 of the guide plates 27, extend through circular pin holes 22 and 24 of the respective plates 23 and 25.

In the conventional chain, teeth (not shown) of the joint link plates 23, and teeth (not shown) of the guide link plate 25 begin engaging the sprocket teeth with their inner flanks, and seat with their outer flanks.

In the conventional silent chain 21, the connecting pins 28 are inserted into circular pin holes 22 and 24 of the respective joint link plates 23 and guide link plates 25 with essentially zero clearance, i.e., only enough clearance to allow the plates to rotate relative to the pins so that the chain can flex. Because of the minimal pin clearance, when an inner flank of a tooth of a link plate first comes into contact with a sprocket tooth to begin engagement therewith, a clashing noise is generated by impact. The conventional chain is unable to meet current demands for reduced noise.

Furthermore, since there is only minimal clearance for the connecting pins, the impact generated at the beginning of engagement is transmitted to the connecting pins and to the pin holes, causing a decrease in the useful life of the chain.

Accordingly, an object of the invention is to provide a silent chain in which, when a tooth of a joint link plate or a tooth of a guide link plate first comes into contact with a sprocket tooth to begin engagement therewith, the impact at the contact is reduced so that clashing noise is reduced, and at the same time the impact transmitted to the connecting pins and pin holes is also reduced, whereby the useful life of the chain is extended.

### SUMMARY OF THE INVENTION

The improved silent chain according to the invention is similar to conventional silent chains in that it comprises a plurality of link plates, each having a pair of pin holes, the link plates being arranged in alternate, interleaved, joint link rows and guide link rows, each joint link row comprising a set of toothed joint link plates having a pair of teeth with inner and outer flanks, and each guide link row comprising a pair of guide plates and a set of toothed guide link plates flanks disposed between the guide plates, said guide link plates also having a pair of teeth with inner and outer flanks; and connecting pins fixed to pin holes in the guide plates and extending through pin holes in overlapping parts of joint link plates and guide link plates, thereby connecting the interleaved joint link rows and guide link rows to form an elongated chain. The connecting pins can be of various types, for example, round pins, and rocker pins composed of a long pin and a short pin.

Preferably, whenever a section of the chain having at least three connecting pins is straight and under tension, the distances between the centers of adjacent connecting pins in that section are equal to one another. Preferably, the chain according to the invention is an inner flank engagement/outer flank seating chain. That is, the teeth of the joint link plates and the teeth of the guide link plates are shaped so that inner flanks of contact sprocket teeth as the chain begins to engage a sprocket, and outer flanks engage sprocket teeth as the chain becomes seated on a sprocket.

The silent chain of the invention differs from a conventional silent chain in that the pin holes in each of joint link plates are elongated in the direction of elongation of the chain, and extend toward each other from the two connecting pins extending through them. As a result of the elongation of the pin holes in the joint link plates, a gap is formed between each of the two connecting pins and the other. The pin holes of each of the toothed guide link plates, on the other hand, are circular pin holes.

As a result of the aforementioned gaps resulting from elongation of the pin holes in the joint link plates, the joint link plates are movable with respect to the connecting pins, and the guide rows and the non-guide rows are relatively movable in the longitudinal direction of the chain. The term “front” with reference to a tooth of a link plate refers to the tooth of a link plate that is ahead of the other tooth with reference to the direction of advance of the chain. Because the guide rows and non-guide rows are relatively movable in the longitudinal direction of the chain, when the inner flank of a front tooth of a joint link plate or the inner flank of a front tooth of a guide link plate of a guide row first comes into contact with a sprocket tooth to begin engagement therewith, the guide row moves slightly forward with respect to a joint link row. As a result the impact at the beginning of engagement of a tooth of a joint link plate or a tooth of a guide link plate with a sprocket tooth is reduced and the clash noise is reduced.

Furthermore, the impact between the connecting pins and the elongated pin holes of the joint link plates is reduced, and at the same time the impact between the connecting pins and the pin holes of the guide link plates is also reduced. The reduction in impact between the link plate teeth and the sprocket teeth, and the reduction of impact between the pins and the pin holes both contribute to a lengthening of the useful life of the silent chain.

In addition, since the pin holes of the joint link plates are elongated, significant quantities of lubricating oil are held in the clearances between the edges of the elongated pin holes and the connecting pins. As a result, wear elongation of the chain is suppressed.

In an alternative embodiment of the invention, the pin holes of each joint link plate can be made continuous with each other. The formation of continuous pin holes simplifies manufacture of the joint link plates.

In accordance with another aspect of the invention, when a joint row plate is seated on a sprocket, the radially outward parts of its elongated pin holes include substantially straight portions that are substantially parallel to a line tangent to a circle centered on and coaxial with the axis of rotation of the sprocket. As a result, the radial distance from the sprocket axis to the substantially straight portion of each elongated pin hole increases with increasing distance from the pin extending therethrough. As the connecting pin shifts from the outer ends of the elongated pins holes in a row of joint link plate toward the inside, the guide link plates through which the pin extends can move slightly radially outward relative to the joint link plate. Impact between the plate teeth and a sprocket tooth is reduced, and a further reduction in engagement noise can be realized.

In accordance with still another aspect of the invention, the length of each gap, measured in the direction of elongation of the chain, preferably exceeds the shortest distance between joint row plates in successive joint rows of the chain, also measured in the direction of elongation of the chain. As a result, an inner flank of a joint link plate and an outer flank of the guide link plate can come into contact with the same sprocket tooth surface, and the surface pressure on each plate is accordingly reduced so that a reduced noise level can be realized.

In an alternative embodiment, the chain according to the invention can be a chain in which the joint link plates are of the inner flank engagement/outer flank seating type while the guide link plates are of the outer flank engagement/outer flank seating type. That is, the teeth of the joint link plates are shaped so that inner flanks of the teeth of the joint link plates contact sprocket teeth as the chain begins to engage a sprocket, and outer flanks of teeth of the joint link plates engage sprocket teeth as the chain becomes seated on a sprocket, and the teeth of the guide link plates are shaped so that outer flanks of teeth of the guide link plates contact sprocket teeth as the chain begins to engage a sprocket, and outer flanks of teeth of the guide link plates engage sprocket teeth as the chain becomes seated on a sprocket. When the inner flank of a front tooth of a joint link plate or an outer flank of a rear tooth of a guide link plate first comes into contact with a sprocket tooth to begin engagement therewith, the guide row shifts slightly forward with respect to the non-guide row because the pin holes of the joint link plates are elongated. As a result, impact at the beginning of engagement of a tooth of the joint link plate or a tooth of the guide link plate with a sprocket tooth is reduced so that clash noise is reduced.

In this embodiment, as in the previously described embodiment, the impact between the connecting pins and the elongated pin holes of the joint link plates is reduced, and at the same time the impact between the connecting pins and the pin holes of the guide link plates is also reduced. The reduction in impact between the link plate teeth and the sprocket teeth, and the reduction of impact between the pins and the pin holes both contribute to a lengthening of the useful life of the silent.

In addition, as in the previously described embodiment, since the pin holes of the joint link plates are elongated, significant quantities of lubricating oil are held in the clearances between the edges of the elongated pin holes and the connecting pins. As a result, wear elongation of the chain is suppressed.

### BRIEF DESCRIPTION OF THE DRAWINGS

FIG. 1 is an elevational view of a joint link plate of a silent chain in accordance with a first embodiment of the invention;

FIG. 2 is an elevational view of a guide link plate of the chain according to the first embodiment;

FIG. 3 is a cross-sectional view of a part of the chain according to the first embodiment;

FIG. 4 is an schematic view showing the engagement of the silent chain of the first embodiment with a sprocket;

FIG. 5 is an elevational view of a part of the chain showing the relationship between the length of a gap between successive joint link plates and the length of a gap between a connecting pin and an inner end of a pin hole in a joint link plate;

FIG. 6 is an elevational view of a joint link plate of a silent chain in accordance with a second embodiment of the invention;

FIG. 7 is an elevational view of a part of a chain according to a third embodiment of the invention, including an enlarged view of a joint link plate of that chain;

FIG. 8 is a schematic elevational view of a joint link plate, showing how oil is held in pin holes of the plate;

FIG. 9 is a schematic plan view of a silent chain showing the chain in a deflected condition; and

FIG. 10 is a cross-sectional view of a part of a conventional silent chain.

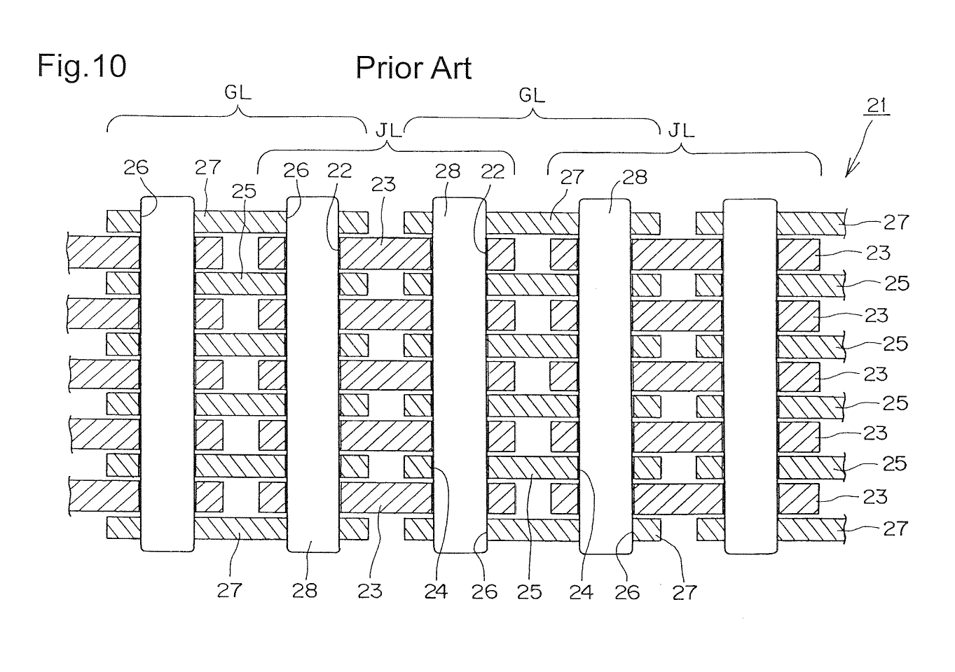

### DETAILED DESCRIPTION OF THE PREFERRED EMBODIMENTS

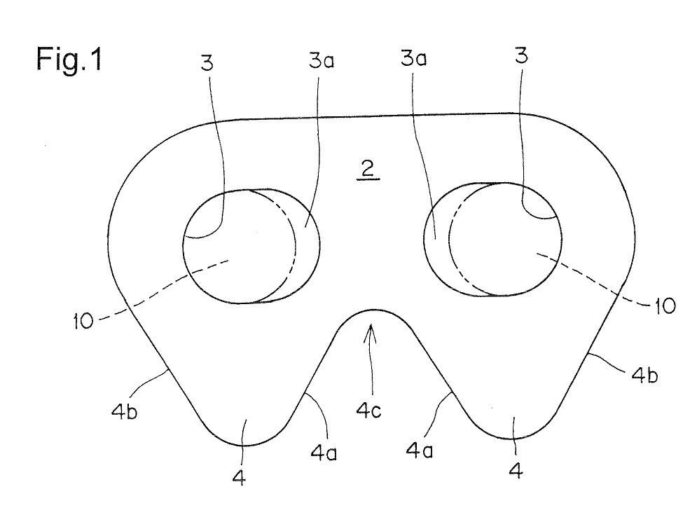

In the first embodiment of the invention, illustrated in FIGS. 1 to 5, the silent chain 1 is formed by a plurality of joint link plates 2 arranged in joint link rows JL, and a plurality of guide link plates 5 arranged guide rows GL. The chain is composed of alternating joint link rows and guide rows, and the plates of the respective rows are interleaved and connected by connecting pins 10, which extend through pin holes 3 and 6.

As shown in FIG. 1, a joint link plate 2 has a pair of pin holes 3, and is bifurcated to form a pair of teeth 4. Each pin hole 3 is an elongated pin hole in the form of a circular pin hole having an expanded portion 3a extending toward the center of the joint link plate, that is, extending in the inside direction of the joint link plate toward the opposite pin hole.

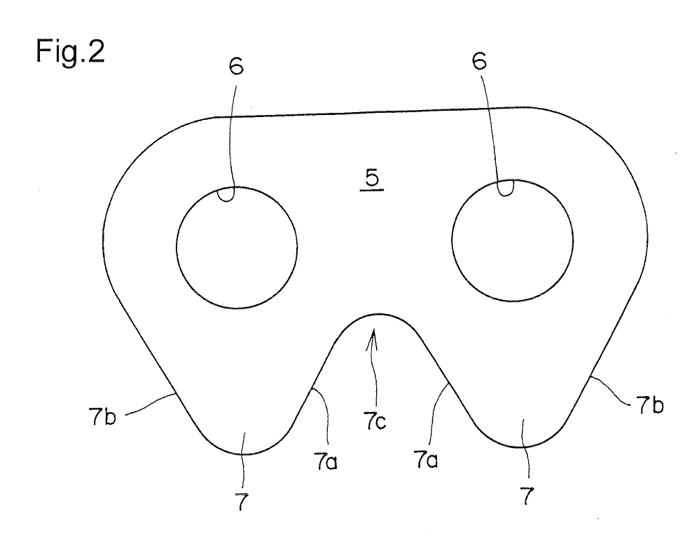

As shown in FIG. 2, the guide link plate 5 is also bifurcated to form a pair of teeth 7, but its pin holes 6 are circular.

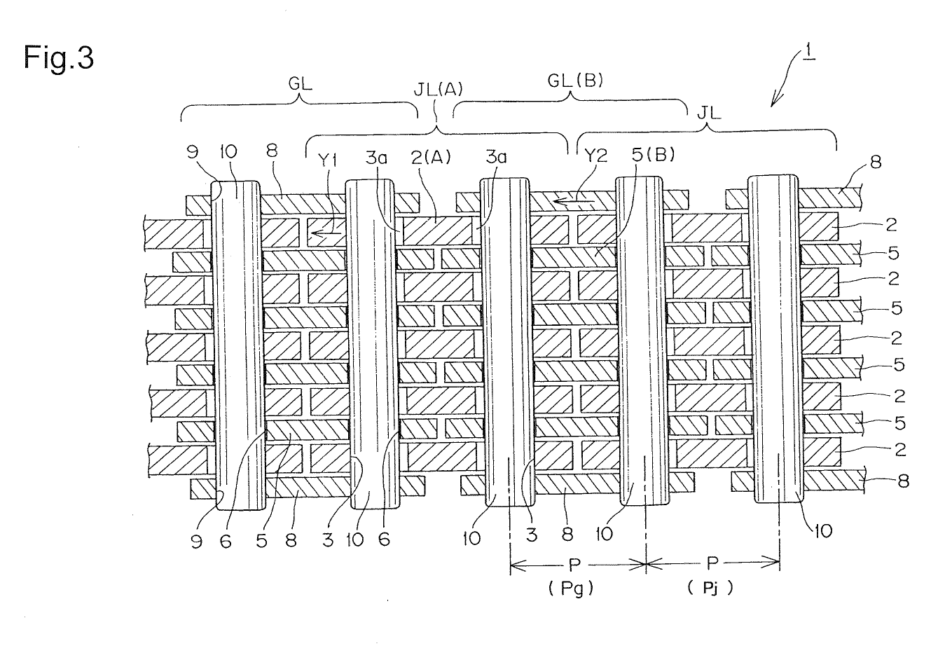

The joint link plates 2 and the guide link plates 5 have the same outer shape, with crotch portions 4c and 7c, respectively. A tooth 4 of a joint link plate 2 and a tooth 7 of a guide link plate 5 begin engagement with a sprocket tooth by contact between its inner flank 4a or 7a with the sprocket tooth. The teeth, however, and seat on the sprocket with outer flanks 4b and 7b in contact with the sprocket teeth. Thus, the chain comprising plates 2 and 5 is an inner flank engagement/outer flank seating type. As shown in FIG. 3, guide plates 8, which are arranged on the opposite ends of each guide row GL along the sides of the chain have a pair of pin holes 9 in which the connecting pins are fixed.

In silent chain 1, as shown in FIG. 3, the connecting pins 10 come into contact with outer edges of the elongated pin holes 3 of the joint link plates 2 in a portion of the chain when that portion of the chain is under tension and extends along a straight line. The distances between the centers of adjacent connecting pins 10 are equal and correspond to the chain reference pitch P. Thus, as shown in FIG. 3, the pitch Pj between the connecting pins 10 of a joint link row JL is equal to the pitch Pg between the connecting pins 10 of a guide link row GL. That is, P=Pg=Pj.

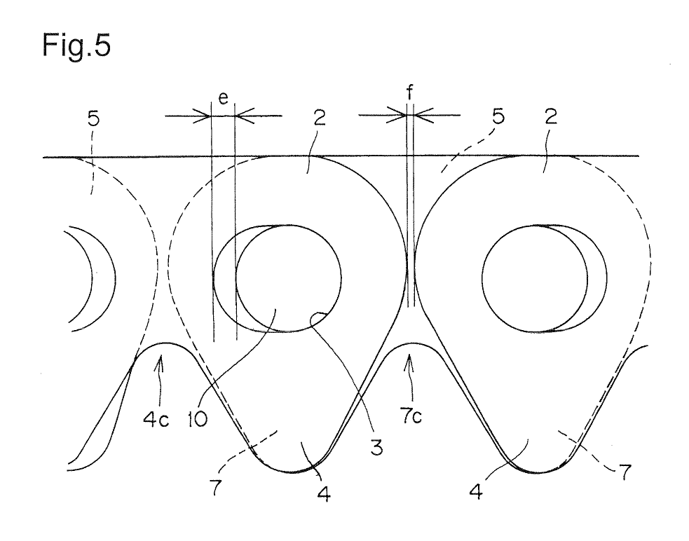

In the silent chain 1, as shown in FIG. 5, the lengthwise dimension e of the expanded portion 3a of the pin hole 3 in the joint link plate 2 may be chosen appropriately. However, it is preferable that the length e of the expanded portion 3a be larger than the shortest distance f between the edges of the successive joint link plates 2. That is, e>f.

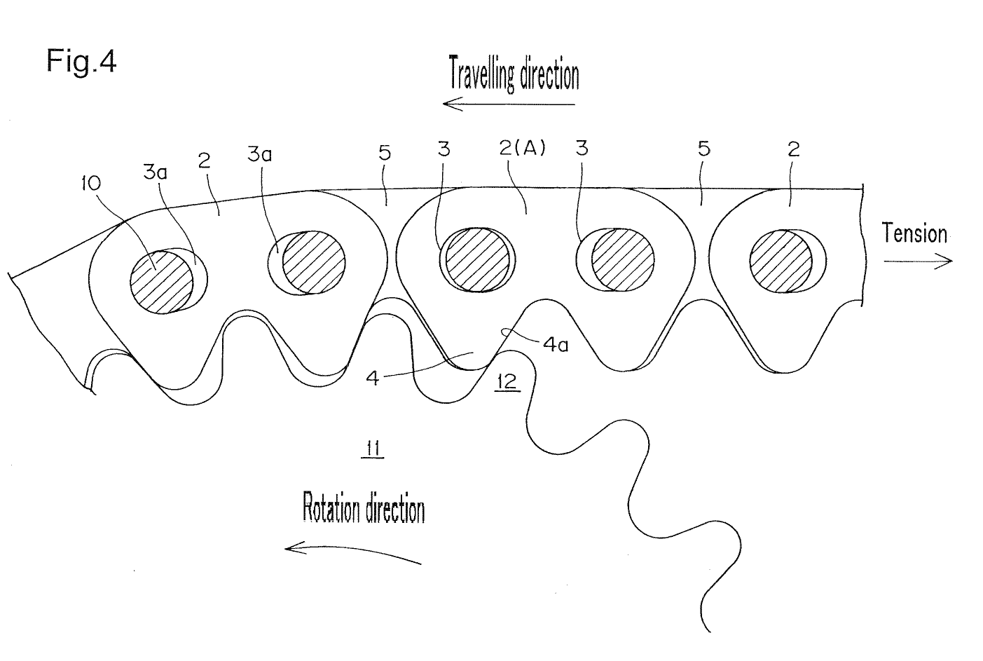

As shown in FIG. 4, where the silent chain 1 is wound around a driving sprocket 11, an inner flank of a front tooth 4 of a joint link plate 2 begins engaging with a sprocket tooth 12, a forward driving force is imparted to the joint link plate 2(A). Since the connecting pin 10 is movable in the direction of the expanded portion 3a within the elongated pin hole 3, the joint link plates 2(A) are movable with respect to the connecting pin 10, and shifts forward slightly in the direction of arrow Y1 in FIG. 3. Accordingly, as shown in FIG. 4, a guide row GL(B), positioned behind the joint link row JL(A), shifts forward slightly in the direction of arrow Y2, and the following portion of the chain is also pulled.

Because the elongation of their pin holes allows the joint link plates to shift with respect to the connecting pins the impact on contact between the tooth 4 of the joint link plate 2(A) and the sprocket tooth 12 is reduced so that the clash noise at the beginning of engagement is reduced.

When a tooth 7 of a guide link plate 5 of a guide row GL begins engaging a sprocket tooth 12, when an inner flank 7a of a front tooth 7 of a guide link plate 5(B) of a guide row GL(B) in FIG. 3 first comes into contact with a sprocket tooth 12, a forward driving force is imparted to the guide link plate 5(B).

Since the connecting pin 10 is movable in the direction of the expanded portion 3a of an elongated pin hole 3, the joint link plates 2 are movable with respect to the connecting pin 10. The guide row GL(B) shifts slightly forward, in a direction of arrow Y2. As a result, the impact on contact between a tooth 7 of a guide link plate 5(B) and a sprocket tooth 12 is reduced, and impact noise at the beginning of engagement is reduced.

Since the impact between the teeth of the chain and the sprocket teeth is reduced, the impact between the connecting pins 10 and the elongated pin holes 3 of the joint link plates 2 is reduced, and, at the same time, the impact between the connecting pins 10 and the pin hole 6 of the guide link plates 5 is also reduced. Therefore, the life of the silent chain is extended.

Since the pin holes 3 of the joint link plates 2 are elongated, as shown in FIG. 5, where the relation e>f is satisfied, when silent chain engages with a sprocket on the slack side of the chain during high speed rotation, the guide row GL(B) shifts at the beginning of engagement. As a result the surface pressure applied to each plate becomes smaller and a low noise level can be obtained.

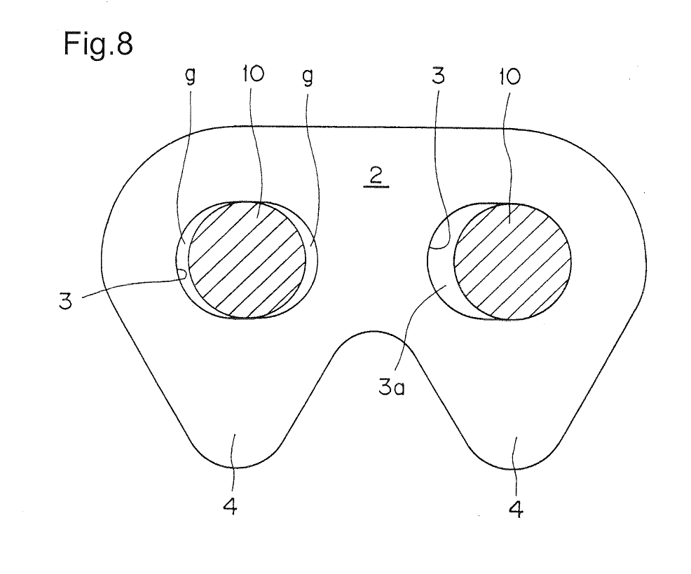

Since the connecting pins 10 are movable in the direction of the expanded portions 3a within the elongated pin holes 3, the clearances g, shown in FIG. 8, between the ends of the elongated pin holes 3 and the connecting pins 10 can hold significant amounts of lubricating oil and contribute to the suppression of wear elongation of the chain.

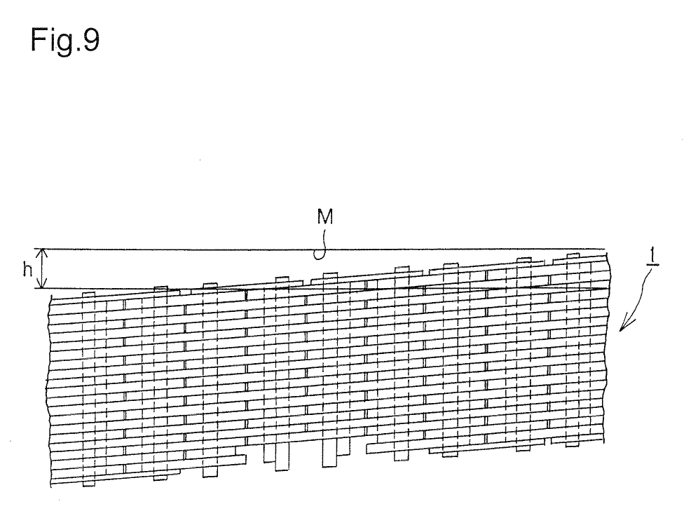

As illustrated in FIG. 9, even though deflection can occur in the chain due to causes such chordal vibration of a free span of the chain, bulging of the slack side of the chain during high speed operation, or an increase in engagement pitch due to a wear elongation, so that a shaft deformation in a transfer case M occurs, since the pin holes 3 of the joint link plate 2 are elongated, the silent chain can follow the deformation and its strength and low noise characteristics can be maintained.

In the above-described embodiment, the silent chain is wound around a driving sprocket 11 (FIG. 4). Even where the silent chain is wound around a driven sprocket, the respective teeth 4 and 7 of the chain on the slack side begin engaging with the sprocket from an inner flank so that impact at the time of contact is reduced. As a result clash noise at the time of beginning of engagement can be reduced.

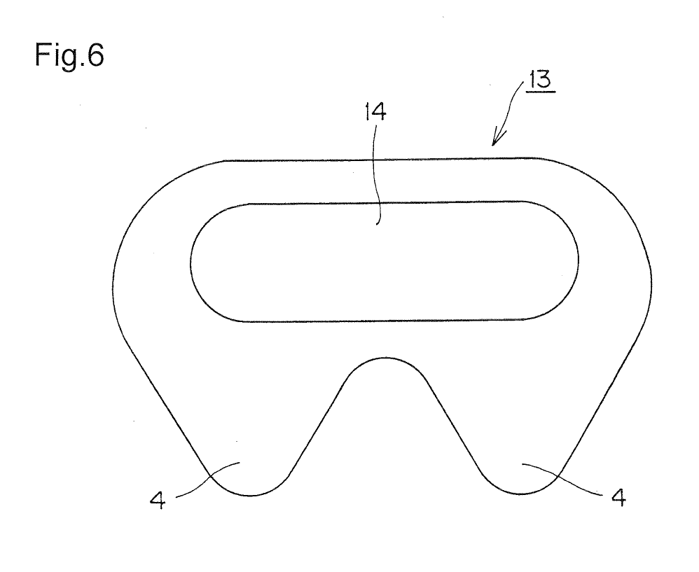

FIG. 6 shows a joint link plate 13 according to a second embodiment of the invention. In this joint link plate 13, the expansion of the pin holes is such that the expanded portions meet each other, so that the pin holes are continuous with each other, forming a single, elongated pin hole 14. The single elongated pin hole structure simplifies the manufacture of the joint link plate. However, the joint link plate has the same operation and effects as the joint link plate of the first embodiment, in which the joint link plate has two separate elongated pin holes.

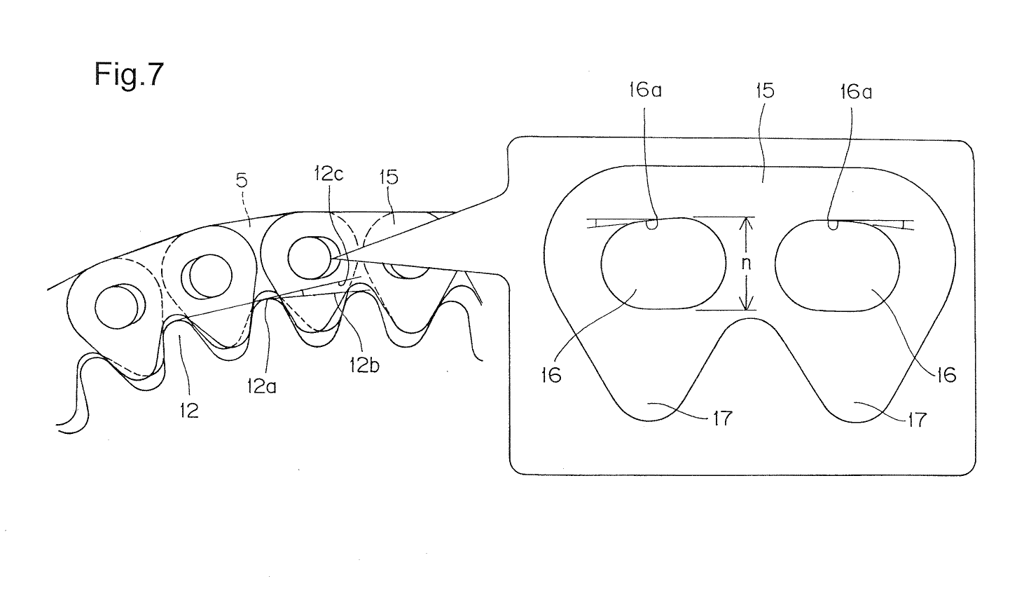

In the third embodiment, as shown in FIG. 7, a joint link plate 15 has elongated pin holes 16, each having a upper side edge 16a, i.e. an edge more remote from the sprocket axis, that is parallel to a line_12c, which is, in turn, parallel to a tangent to a circle 12b circumscribed about the sprocket at the location of the sprocket tooth heads engaged with the each outer flank of the joint link plate 17.

This pin hole structure allows the connecting pin to shift easily from an outer edge toward the inside of the pin hole so that the joint link plate 15 move easily with respect to the connecting pin 10.

As a result, impact at the time of contact between a tooth 17 of the joint link plate 15 and a sprocket tooth 12 is reduced so that the clash noise at the time of engagement is further reduced.

In a fourth embodiment of the invention, not illustrated separately, the guide link plates of the silent chain are changed to outer flank engagement/outer flank seating guide link plates. The longitudinal cross-section of the chain is as shown in FIG. 3, and the chain of the fourth embodiment will be described using the same reference numerals as used to describe the first embodiment.

In the silent chain of the fourth embodiment, a plurality of joint link plates 2, each having a pair of elongated pin holes 3 and a pair of teeth, are arranged in joint link rows JL, a plurality of guide link plates each having a pair of circular pin holes and a pair of teeth are arranged in guide rows GL. Guide plates 8, each having a pair of pin holes 9, are disposed at the at the ends of the guide rows. The joint link plates 2 are interleaved with the guide link plates and the joint links and guide links are connected by connecting pins 10, which extend through pin holes in the joint link plates and guide link plates and are fixed to pin holes 9 of the guide plates.

In this silent chain, as in the first embodiment, teeth of the joint link plate 2 begin engaging with the sprocket tooth 12 with their inner flanks in contact with the sprocket teeth, and upon completion of engagement, these joint link plates seat on the sprocket with their outer flanks in engagement with the sprocket teeth. However, the teeth of the guide link plates begin engagement with a sprocket teeth 12 with an outer flank in contact with a sprocket tooth, and, on completion of engagement, seat on the sprocket with their outer flanks in contact with sprocket teeth.

In the fourth embodiment, when an inner flank of a front tooth of a joint link plate 2 of a joint link row JL first comes into contact with a sprocket tooth, or when an outer flank of a rear tooth of a guide link plate of a guide row GL first comes into contact with a sprocket tooth, since the elongated pin holes 3 of the joint link plates 2 allow the joint link plates 2 to move with respect to the connecting pins, the guide row GL shifts forward slightly with respect to the joint link row JL. Therefore, the impact at the time of contact between teeth of the joint link plates or teeth of the guide link plates and a sprocket tooth is reduced, so that the clash noise at the beginning of engagement is reduced.

Since the impact at the beginning of engagement is reduced, the impact between the connecting pins 10 and the elongated pin holes 3 of the joint link plates is reduced, and, at the same time, impact between the connecting pins 10 and the pin holes 6 of the guide link plates 5 is also reduced. Thus the life of the silent chain is extended. Here as in the other embodiments, since the pin holes are elongated, the clearances between the connecting pins and the ends of the pin holes can hold significant quantities of oil which can suppress wear elongation.

In the chain according to the invention, movements in the radial direction at the point of engagement due to polygonal movement, and noise due to chordal vibrations can be suppressed by adoption of structures in which the pitch of the sprocket teeth is related to the pitch of the plate teeth, in the well-known manner described in publications such as Japanese patent Nos. 3076022, 3187802, 3108417.

We claim:

1. A silent chain comprising:
a plurality of link plates, each having a pair of pin holes, the link plates being arranged in alternate, interleaved, joint link rows and guide link rows, each joint link row comprising a set of toothed joint link plates having a pair of teeth with inner and outer flanks, and each guide link row comprising a pair of guide plates and a set of toothed guide link plates flanks disposed between the guide plates, said guide link plates also having a pair of teeth with inner and outer flanks; and
connecting pins fixed to pin holes in the guide plates and extending through pin holes in overlapping parts of joint link plates and guide link plates, thereby connecting the interleaved joint link rows and guide link rows to form an elongated chain;
in which:
the pair of pin holes in each of joint link plate are elongated in the direction of elongation of the chain and extend toward each other from the two connecting pins extending through said pair of pin holes, whereby a gap is formed between each of said two connecting pins and the other;
the pair of pin holes of each of the toothed guide link plates are circular pin holes;
whenever a section of the chain having at least three connecting pins is straight and under tension, the distances between the centers of adjacent connecting pins in said section are equal to one another; and
the teeth of the joint link plates and the teeth of the guide link plates are shaped so that inner flanks of said teeth contact sprocket teeth as the chain begins to engage a sprocket, and outer flanks of said teeth engage sprocket teeth as the chain becomes seated on a sprocket.

2. A silent chain according to claim 1, in which the pin holes of each joint link plate are continuous with each other.

3. A silent chain according to claim 1, in which, when a joint row plate is seated on a sprocket, the radially outward parts of its elongated pin holes include substantially straight portions that are substantially parallel to a line tangent to a circle centered on and coaxial with the axis of rotation of the sprocket, whereby the radial distance from said axis to said substantially straight portion of each elongated pin hole increases with increasing distance from the pin extending therethrough.

4. A silent chain according to claim 1, in which the length of each said gap, measured in the direction of elongation of the chain, exceeds the shortest distance between joint row plates in successive joint rows of the chain, also measured in the direction of elongation of the chain.

5. A silent chain comprising:
a plurality of link plates, each having a pair of pin holes, the link plates being arranged in alternate, interleaved, joint link rows and guide link rows, each joint link row comprising a set of toothed joint link plates having a pair of teeth with inner and outer flanks, and each guide link row comprising a pair of guide plates and a set of toothed guide link plates flanks disposed between the guide plates, said guide link plates also having a pair of teeth with inner and outer flanks; and
connecting pins fixed to pin holes in the guide plates and extending through pin holes in overlapping parts of joint link plates and guide link plates, thereby connecting the interleaved joint link rows and guide link rows to form an elongated chain;
in which:
the pair of pin holes in each of joint link plate are elongated in the direction of elongation of the chain and extend toward each other from the two connecting pins extending through said pair of pin holes, whereby a gap is formed between each of said two connecting pins and the other;
the pin holes of each of the toothed guide link plates are circular pin holes;
whenever a section of the chain having at least three connecting pins is straight and under tension, the distances between the centers of adjacent connecting pins in said section are equal to one another; and
the teeth of the joint link plates are shaped so that inner flanks of teeth of the joint link plates contact sprocket teeth as the chain begins to engage a sprocket, and outer flanks of teeth of the joint link plates engage sprocket teeth as the chain becomes seated on a sprocket; and
the teeth of the guide link plates are shaped so that outer flanks of teeth of the guide link plates contact sprocket teeth as the chain begins to engage a sprocket, and outer flanks of teeth of the guide link plates engage sprocket teeth as the chain becomes seated on a sprocket.
